(19) United States
(12) Patent Application Publication
(10) Pub. No.: US 2012/0114456 A1
(43) Pub. Date: May 10, 2012

(54) HOLDING APPARATUS, CONVEYING APPARATUS, AND ROTATION-TRANSMITTING APPARATUS

(76) Inventors: Kazuhiro Musha, Kanagawa (JP); Hirofumi Minami, Kanagawa (JP); Hidenobu Anzai, Saitama (JP); Koji Sakurai, Saitama (JP); Tojiro Aoyama, Kanagawa (JP); Yasuhiro Kakinuma, Kanagawa (JP)

(21) Appl. No.: 13/262,175

(22) PCT Filed: Mar. 30, 2010
(86) PCT No.: PCT/JP2010/002330

§ 371 Date: Sep. 29, 2011

(30) Foreign Application Priority Data
Mar. 31, 2009 (JP) 2009 087479

(51) Int. Cl. B65G 47/90; B66F 19/00

(52) U.S. Cl. 414/751.1; 294/212

(57) ABSTRACT

A holding apparatus, a conveying apparatus, and a rotation-transmitting apparatus are provided that are capable of stably holding an object while suppressing an influence of a change in shape of the object and a fluctuation of a holding form. A conveying apparatus according to one form of the present invention includes a hand and a holding body provided on the hand. The holding body includes a holding member that includes a holding surface that comes into close contact with a holding object, the holding member being capable of holding a conveying object on the holding surface, and a viscoelastic member that is formed of a viscoelastic material and bonds the hand to the holding member. By the viscoelastic member being elastically deformed and the entire surface of the holding member being brought into close contact with the holding object, the conveying apparatus is capable of holding the conveying object on the hand.

### TECHNICAL FIELD

The present invention relates to a holding apparatus that holds an object in an inclinable manner, a conveying apparatus, and a rotation-transmitting apparatus.

### BACKGROUND ART

In conveying apparatuses that convey semiconductor substrates for LSI (Large Scale Integration), glass substrates for display, and the like (hereinafter, referred to as substrate), there are apparatuses that hold a substrate using a hand attached at a tip end of a robot arm and convey the substrate by operating the arm. The substrate is held in the arm by a holding apparatus provided in the hand. Since high positioning accuracy is required in conveying substrates, the holding apparatus is required to surely hold a substrate, and thus there are various forms of holding apparatuses.

For example, Patent Document 1 discloses a holder including a functional adhesive element. The holder holds and conveys a substrate as a conveying object using a holding body that is constituted of a functional adhesive element and provided on a hand of a substrate conveying robot. The functional adhesive element enables substrates to be surely held based on a fluctuation of an adhesive force due to an applied voltage.
Patent Document 1: Japanese Patent Application Laid-open No. 2008-47700 (paragraph [0013], FIG. 1)

### DISCLOSURE OF THE INVENTION

### Problems to be Solved by the Invention

However, the holder of Patent Document 1 has a structure in which the functional adhesive element is fixed on the hand. Therefore, entire surfaces of the functional adhesive element and substrate are not brought into close contact with each other unless the hand and the substrate are completely in parallel, with the result that the substrate cannot be held sufficiently. The hand may have a deflection caused by its own weight or movement, and the substrate may also have a deformation (warpage) caused by heating processing and the like.

In view of the circumstances as described above, it is an object of the present invention to provide a holding apparatus, a conveying apparatus, and a rotation-transmitting apparatus that are capable of stably holding an object while suppressing an influence of a change in shape of the object and a fluctuation of a holding form.

### Means for Solving the Problems

According to an embodiment of the present invention, there is provided a holding apparatus including a base body and a holding body.

The holding body includes a holding surface that comes into close contact with a holding object and a bonding layer that is formed of a viscoelastic material and bonds the holding surface to the base body.

A conveying apparatus according to an embodiment of the present invention includes the holding apparatus on a conveying surface.

A rotation-transmitting apparatus according to an embodiment of the present invention includes a first spinning disk and a second spinning disk.

The first spinning disk includes a base body including a rotation axis, a holding surface, and a bonding layer that is formed of a viscoelastic material and bonds the holding surface to the base body.

The second spinning disk comes into close contact with the holding surface.

According to an embodiment of the present invention, there is provided a conveying apparatus including a stator and a movable element.

The movable element includes a base body on which a conveying object is mounted, a contact surface that is formed of an electric adhesive material and comes into contact with the stator, and a bonding layer that is formed of a viscoelastic material and bonds the contact surface to the base body, the movable element being moved relative to the stator.

According to another embodiment of the present invention, there is provided a conveying apparatus including a movable element and a stator.

On the movable element, a conveying object is mounted.

The stator includes a base body, a contact surface that is formed of an electric adhesive material and comes into contact with the movable element, and a bonding layer that is formed of a viscoelastic material and bonds the contact surface to the base body, the stator being moved relative to the movable element.

### BRIEF DESCRIPTION OF DRAWINGS

FIG. 1 A perspective view showing a conveying apparatus 1 according to a first embodiment of the present invention.

FIG. 2 A perspective view showing a hand 4.

FIG. 3 A cross-sectional diagram showing holding bodies 5.

FIG. 4 Schematic diagrams showing details of the holding body 5.

FIG. 5 Cross-sectional diagrams showing an operation of the holding bodies 5.

FIG. 6 A cross-sectional diagram showing the holding bodies 5.

FIG. 7 A cross-sectional diagram showing holding bodies 21 according to a second embodiment of the present invention.

FIG. 8 A cross-sectional diagram showing the holding bodies 21.

FIG. 9 A cross-sectional diagram showing holding bodies 31 according to a third embodiment of the present invention.

FIG. 10 A cross-sectional diagram showing a holding body 41 according to a fourth embodiment of the present invention.

FIG. 11 A cross-sectional diagram showing a holding body 51 according to a fifth embodiment of the present invention.

FIG. 12 A cross-sectional diagram showing a rotation-transmitting apparatus 60 according to a sixth embodiment of the present invention.

FIG. 13 A cross-sectional diagram showing an operation of a holding member 67.

FIG. 14 A perspective view showing a conveying apparatus 80 according to a seventh embodiment of the present invention.

FIG. 15 A perspective view showing a movable portion 83 and a fixing portion 84.

FIG. 16 Cross-sectional diagrams showing operations of the conveying apparatus 80.

### BEST MODES FOR CARRYING OUT THE INVENTION

A holding apparatus according to a first embodiment of the present invention includes a base body and a holding body.

The holding body includes a holding surface that comes into close contact with a holding object and a bonding layer that is formed of a viscoelastic material and bonds the holding surface to the base body.

With this structure, due to an elastic deformation of the bonding layer, an entire surface of a holding portion is brought into close contact with the holding object, with the result that the holding object can be held on the base body.

Here, the “viscoelastic material” includes, for example, rubber and an elastomer material such as thermoplastic elastomer.

The holding body may further include a holding layer including the holding surface, and the bonding layer may bond the holding layer to the base body.

With this structure, due to an elastic deformation of the bonding layer, the holding layer can follow the holding object.

The holding surface may be formed of an electric adhesive material that is capable of electrically changing an adhesive force.

With this structure, it is possible to lower the adhesive force at a time the holding object is attached/detached to/from the holding surface and enhance the adhesive force at a time the holding object is held.

The holding layer may further include an electric field applying means for applying an electric field to the electric adhesive material.

With this structure, by the electric field applying means incorporated into the holding layer, the adhesive force of the electric adhesive material can be changed.

The electric field applying means may be constituted of an insulator layer formed on the bonding layer and an electrode layer formed on the insulator layer.

With this structure, as a voltage is applied to the electrode layer, an electric field is applied to the electric adhesive material. The insulator layer electrically insulates the electrode layer and the base body.

The holding layer may be divided plurally for each area on the bonding layer.

With this structure, each holding layer can independently follow the holding object.

The holding body may be divided plurally for each area on the base body.

With this structure, each holding body can independently follow the holding object.

The base body may include a plurality of concave portions, and the holding body may be accommodated in each of the concave portions.

With this structure, it is possible to adjust a height of the holding body protruding from the front surface of the base body.

The holding body may be constituted of the bonding layer alone that includes the holding surface on a front surface thereof, and viscoelasticity of the bonding layer may gradually decrease from the holding surface side to the base body side.

With this structure, by the single-layer bonding layer, a holding body including a portion having high viscoelasticity for supporting the holding object and a portion having low viscoelasticity for allowing an elastic deformation can be formed.

According to an embodiment of the present invention, there is provided a conveying apparatus including the holding apparatus, the holding apparatus being provided on a conveying surface of the conveying apparatus.

With this structure, it is possible to stably hold a conveying object by the holding apparatus and convey it.

According to an embodiment of the present invention, there is provided a rotation-transmitting apparatus including a first spinning disk and a second spinning disk.

The first spinning disk includes a base body including a rotation axis, a holding surface, and a bonding layer that is formed of a viscoelastic material and bonds the holding surface to the base body.

The second spinning disk comes into close contact with the holding surface.

With this structure, even when the rotation axes of the first spinning disk and second spinning disk are not in the same straight line, the rotation of one of the spinning disks can be transmitted to the other spinning disk.

According to an embodiment of the present invention, there is provided a conveying apparatus including a stator and a movable element.

The movable element includes a base body on which a conveying object is mounted, a contact surface that is formed of an electric adhesive material capable of electrically changing an adhesive force and comes into contact with the stator, and a bonding layer that is formed of a viscoelastic material and bonds the contact surface to the base body, the movable element being moved relative to the stator.

With this structure, by an elastic deformation of the bonding layer, the contact surface can be uniformly brought into contact with the stator.

According to another embodiment of the present invention, there is provided a conveying apparatus including a movable element and a stator.

On the movable element, a conveying object is mounted.

The stator includes a base body, a contact surface that is formed of an electric adhesive material capable of electrically changing an adhesive force and comes into contact with the movable element, and a bonding layer that is formed of a viscoelastic material and bonds the contact surface to the base body. The movable element moves relative to the stator.

With this structure, by an elastic deformation of the bonding layer, the contact surface can be uniformly brought into contact with the movable element.

The conveying apparatus may further include a control unit configured to control the adhesive force of the electric adhesive material based on voltage application control. The control unit may inhibit, by applying an electric field to the electric adhesive material, a relative movement of the movable element with respect to the stator and allow, by canceling the application of an electric field to the electric adhesive material, the relative movement of the movable element with respect to the stator.

With this structure, it is possible to fix the movable element to the stator and release the fixed state.

Hereinafter, embodiments of the present invention will be described with reference to the drawings.

### First Embodiment

A conveying apparatus 1 according to a first embodiment will be described.

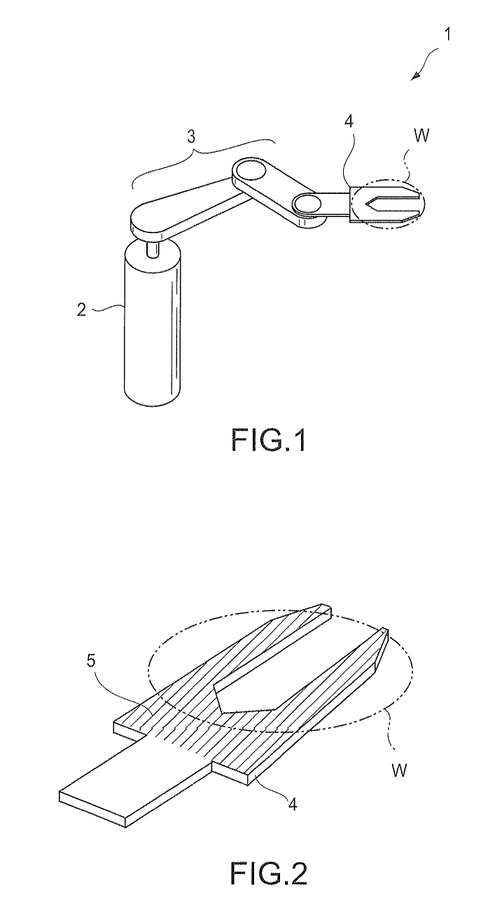

FIG. 1 is a perspective view showing the conveying apparatus 1.

The conveying apparatus 1 of this embodiment is structured as a substrate conveying apparatus that holds and conveys a substrate in vacuum or in the atmosphere.

As shown in the figure, the conveying apparatus 1 includes a driving portion 2, an arm 3, and a hand 4. The driving portion 2 is coupled to one end of the arm 3, and the hand 4 is coupled to the other end of the arm 3. Further, on the hand 4, a substrate W as a conveying object is mounted.

The driving portion 2 drives the arm 3. The driving portion 2 has a power source such as an electric motor and a power-transmitting mechanism incorporated therein so as to be capable of driving the arm 3. The structure of the driving portion 2 is not limited to that described above.

The arm 3 supports the hand 4. The arm 3 is structured to be capable of turning, expanding and contracting, etc. by power transmitted from the driving portion 2 and thus move the hand 4. The arm 3 has a multi-joint structure, but the structure is not limited thereto.

The hand 4 holds the substrate W. The hand 4 is structured to be capable of obtaining and releasing the substrate W.

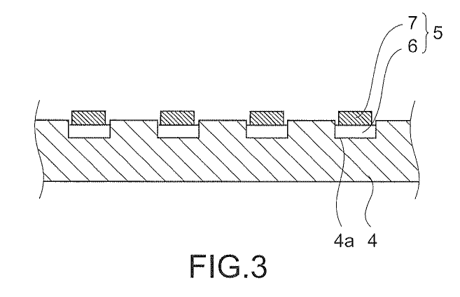

The structure of the hand 4 will be described in detail with reference to FIGS. 2 and 3.

FIG. 2 is a perspective view showing the hand 4.

FIG. 3 is a cross-sectional diagram showing holding bodies 5.

As shown in the figures, the hand 4 is formed of a metal material or the like and formed as a U-shaped plate. However, the shape of the hand 4 is not limited thereto. The hand 4 is attached to the arm 3 such that its surface becomes horizontal.

On one surface of the hand 4 (base body), the holding bodies 5 are provided. The plurality of holding bodies 5 are arranged in an area on the one surface of the hand 4 at certain intervals. The arrangement of the holding bodies 5 is not limited thereto and may be changed as appropriate based on a size, shape, and the like of the conveying object. At positions where the holding bodies 5 of the hand 4 are formed, one cylindrical concave portion 4a is formed for each holding body 5.

The structure of the holding bodies 5 will be described in detail.

As shown in FIG. 3, the holding bodies 5 each include a viscoelastic member 6 (bonding layer) and a holding member 7 (holding layer). The viscoelastic member 6 is formed on the hand 4, and the holding member 7 is formed on the viscoelastic member 6.

The viscoelastic member 6 bonds the hand 4 and the holding member 7 and is structured as a bonding layer that is formed of a (flexible) viscoelastic material that can be elastically deformed. The viscoelastic member 6 supports the holding member 7 such that it can be displaced. The viscoelastic member 6 is formed of elastomer that fills the concave portion 4a to a predetermined level from the bottom. The viscoelastic member 6 is formed of a softer material than the holding member 7.

The holding member 7 is supported by the viscoelastic member 6 and supports the substrate W. The holding member 7 is provided on the viscoelastic member 6 and formed such that its holding surface becomes higher than the front surface of the hand 4.

The holding member 7 is formed to be cylindrical with a smaller diameter than the concave portion 4a. The shape of the holding member 7 is not limited thereto, and a shape including a disk-like holding surface having a larger diameter as shown in FIG. 6, or the like is also possible.

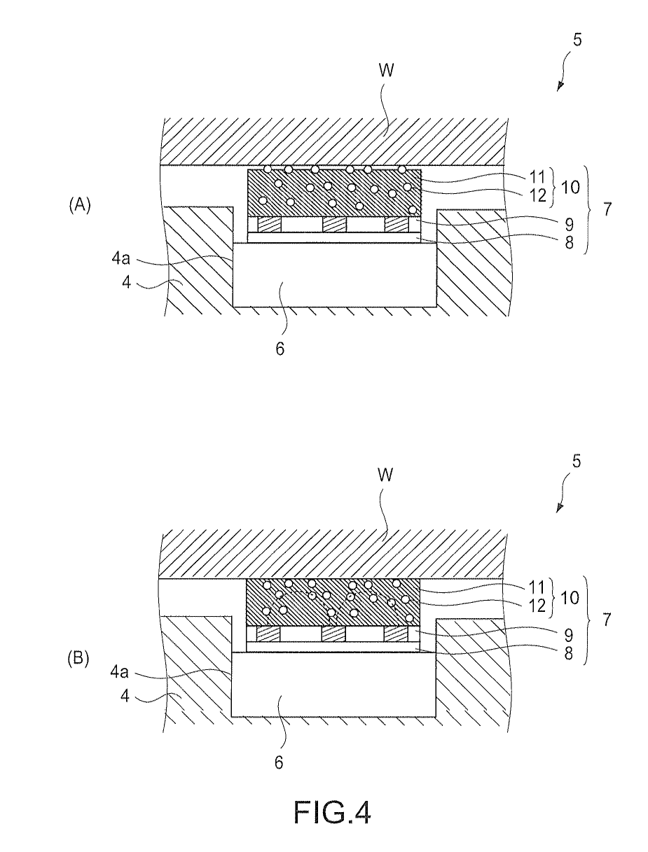

FIG. 4 are schematic diagrams showing details of the holding body 5.

As shown in the figures, the holding member 7 includes an insulator layer 8, an electrode layer 9, and an adhesive layer 10. Those layers are laminated in the stated order from the insulator layer 8, the electrode layer 9, and the adhesive layer 10 from the viscoelastic member 6 side. The adhesive layer 10 is formed of an electric adhesive material. It should be noted that the electrode layer 9 may be pectinated.

The insulator layer 8 electrically insulates the electrode layer 9 and the viscoelastic member 6.

The electrode layer 9 applies an electric field to the adhesive layer 10 by a voltage applied from an external power source.

The adhesive layer 10 changes its adhesion by the electric field generated by the electrode layer 9 (electric adhesion effect) and adheres or releases the adhesion onto/from the substrate W.

The adhesive layer 10 is constituted of an adhesive medium 11 and electric rheology particles 12 dispersed in the adhesive medium 11. The adhesive medium 11 is a gel-type insulation material such as a fluorine-based resin and a silicone resin and has an adhesive force. The “electric rheology particles 12” is a collective term for a particle-type dielectric material, a particle-type semiconductor material, or a particle material as a complex of those two.

The electric adhesion effect of the adhesive layer 10 will be described in detail.

FIG. 4(A) shows the adhesive layer 10 in a state where no voltage is applied, and FIG. 4(B) shows the adhesive layer 10 in a state where a voltage is applied.

In the state where no voltage is applied as shown in FIG. 4(A), the electric rheology particles 12 are dispersed and held in the adhesive medium 11 and are protruding from the front surface of the adhesive layer 10. Accordingly, a contact area between the substrate W and the adhesive medium 11 becomes small, and an adhesive force between the substrate W and the adhesive layer 10 becomes small (or is lost). When a voltage is applied to the electrode layer 9, the state shifts to the state where a voltage is applied as shown in FIG. 4(B).

In the state where a voltage is applied as shown in FIG. 4(B), the electric rheology particles 12 cause dielectric polarization by the voltage applied to the electrode layer 9 and aggregate on a line of electric force, which are exaggerated in the figure to held understand the description. The electric rheology particles 12 protruding from the front surface of the adhesive layer 10 sink in the adhesive medium 11. As a result, the contact area between the substrate W and the adhesive medium 11 increases, and the adhesive force between the substrate W and the adhesive layer 10 increases. The level of aggregation of the electric rheology particles depends on the level of voltage applied to the electrode layer 9. Therefore, it is possible to control the adhesive force based on the voltage level.

As described above, the adhesive force between the substrate W and the adhesive layer 10 can be adjusted based on whether a voltage is applied to the electrode layer 9.

The holding body 5 is structured as described above.

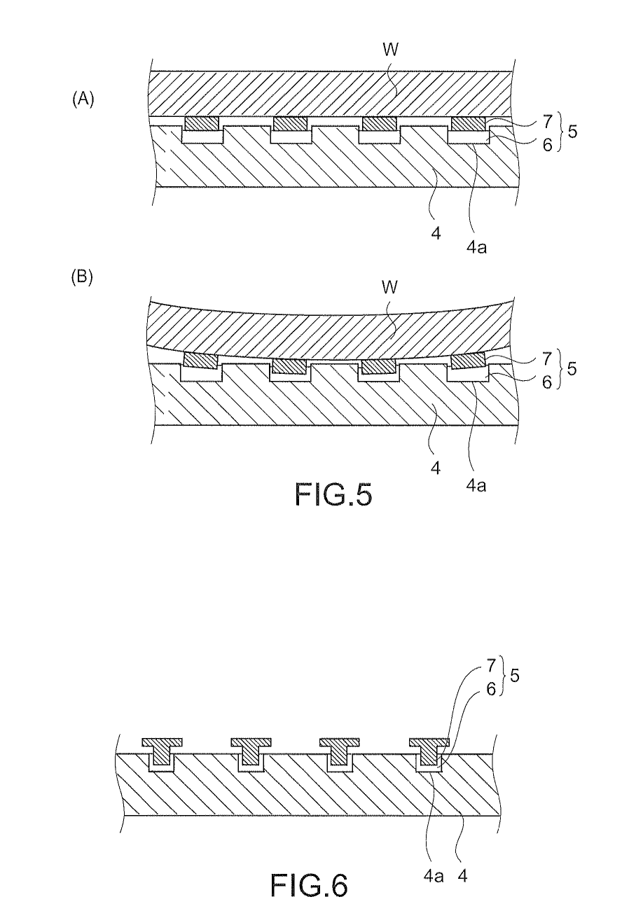

FIG. 5 are diagrams showing an operation of the holding bodies 5.

As shown in FIG. 5(A), when a voltage is applied to the electrode layer 9 after the substrate W is brought into contact with the adhesive layer 10, the adhesive layer 10 adheres onto the substrate W.

As shown in FIG. 5(B), when the substrate W is warped with respect to the surface of the hand 4, the viscoelastic member 6 of the holding body 5 that is in contact with the substrate W is elastically deformed to thus displace (tilt, move, etc.) the holding member 7. Therefore, it becomes possible for the entire surface of the adhesive layer 10 of all (or a large portion) of the holding bodies 5 to adhere onto the substrate W. By the elastic deformation of the viscoelastic member 6, the displacement amount of the holding member 7 becomes larger than that of a case where only the holding member 7 is elastically deformed. As a result, the substrate W can be surely held.

The substrate W is moved as the driving portion 2 is driven while the substrate W is held. At a predetermined position, the voltage application to the electrode layer 9 is stopped so that the adhesive force of the adhesive layer 10 becomes low and the substrate W is released from its held state to be released from the hand 4. It should be noted that during conveyance, some kind of processing (cooling etc.) may be carried out on the substrate W.

### Second Embodiment

A conveying apparatus according to a second embodiment will be described.

In descriptions below, descriptions on parts having the same structures as those of the above embodiment will be simplified.

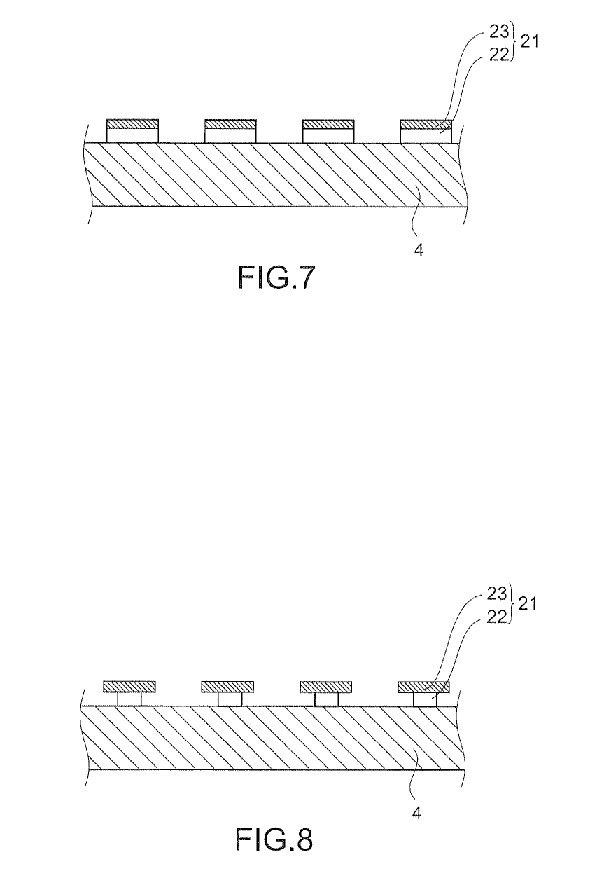

FIG. 7 is a cross-sectional diagram showing holding bodies 21.

As shown in the figure, the holding bodies 21 each include a viscoelastic member 22 (bonding layer) and a holding member 23 (holding layer). The viscoelastic member 22 is formed on the hand 4 (base body), and the holding member 23 is formed on the viscoelastic member 22.

The viscoelastic member 22 bonds the hand 4 and the holding member 23 and is structured as a bonding layer that is formed of a viscoelastic material that can be elastically deformed. The viscoelastic member 22 supports the holding member 23 such that it can be displaced. The viscoelastic member 22 is formed of elastomer provided on the front surface of the hand 4. The viscoelastic member 22 is formed in, for example, a cylindrical shape, and a plurality of viscoelastic members 22 are arranged. The viscoelastic members 22 are each formed of a softer material than the holding member 23.

The holding member 23 is supported by the viscoelastic member 22 and includes a holding surface that holds the substrate W. The holding member 23 is provided one each on the viscoelastic member 22.

The holding member 23 is formed in a disk shape that has the same diameter as the viscoelastic member 22. However, the shape of the holding member 23 is not limited thereto, and a disk shape having a larger diameter than the viscoelastic member 22 may be used instead.

The holding member 23 has the same structure as the holding member 7 according to the first embodiment above, and the holding surface thereof is formed of an electric adhesive material that is capable of electrically changing an adhesive force.

When the substrate W is warped with respect to the surface of the hand 4, the viscoelastic member 22 of the holding body 21 that is in contact with the substrate W is elastically deformed to thus displace (tilt, move, etc.) the holding member 23. Therefore, becomes possible for the entire surface of the adhesive layer 10 of all (or a large portion) of the holding bodies 21 to adhere onto the substrate W.

As a result, this embodiment bears the same effect as the first embodiment.

### Third Embodiment

A conveying apparatus according to a third embodiment will be described.

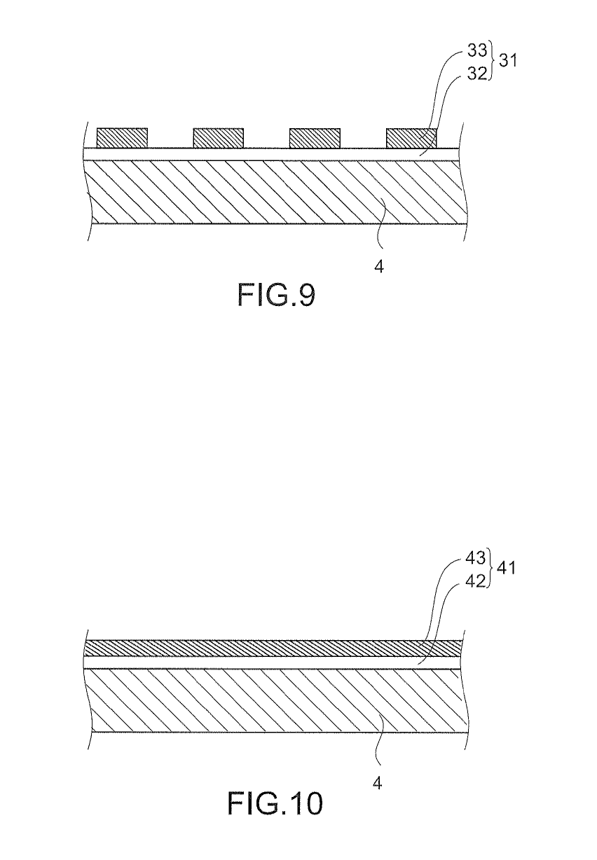

FIG. 9 is a cross-sectional diagram showing holding bodies 31.

In descriptions below, descriptions on parts having the same structures as those of the above embodiments will be simplified.

As shown in the figure, the holding bodies 31 each include a viscoelastic member 32 (bonding layer) and a holding member 33 (holding layer). The viscoelastic member 32 is formed on the hand 4 (base body), and the holding member 33 is formed on the viscoelastic member 32.

The viscoelastic member 32 bonds the hand 4 and the holding member 33 and is structured as a bonding layer that is formed of a viscoelastic material that can be elastically deformed. The viscoelastic member 32 supports the holding member 33 such that it can be displaced. The viscoelastic member 32 is formed of elastomer provided on the front surface of the hand 4. The viscoelastic member 32 is formed as a single layer that is continuous across a certain range of the surface of the hand 4 within a plane. The viscoelastic member 32 is formed of a softer material than the holding member 33.

The holding members 33 are commonly supported by the viscoelastic member 32 and each include a holding surface that holds the substrate W. The plurality of holding members 33 each having a disk shape are arranged on the viscoelastic member 32.

The holding member 33 has the same structure as the holding member 7 according to the first embodiment above, and the holding surface thereof is formed of an electric adhesive material that is capable of electrically changing an adhesive force.

When the substrate W is warped with respect to the surface of the hand 4, the viscoelastic member 32 of the holding body 31 that is in contact with the substrate W is elastically deformed to thus displace (tilt, move, etc.) the holding members 33. Therefore, it becomes possible for the entire surface of the adhesive layer 10 of all (or a large portion) of the holding bodies 31 to adhere onto the substrate W.

As a result, this embodiment also bears the same effect as the first embodiment.

### Fourth Embodiment

A conveying apparatus according to a fourth embodiment will be described.

FIG. 10 is a cross-sectional diagram showing a holding body 41.

In descriptions below, descriptions on parts having the same structures as those of the above embodiments will be simplified.

As shown in the figure, the holding body 41 includes a viscoelastic member 42 (bonding layer) and a holding member 43 (holding layer). The viscoelastic member 42 is formed on the hand 4 (base body), and the holding member 43 is formed on the viscoelastic member 42.

The viscoelastic member 42 bonds the hand 4 and the holding member 43 and is structured as a bonding layer that is formed of a viscoelastic material that can be elastically deformed. The viscoelastic member 42 supports the holding member 43 such that it can be displaced. The viscoelastic member 42 is formed of elastomer provided on the front surface of the hand 4. The viscoelastic member 42 is formed as a single layer that is continuous across a certain range of the surface of the hand 4 within a plane. The viscoelastic member 42 is formed of a softer material than the holding member 43.

The holding member 43 is formed as a single layer that is laminated on the viscoelastic member 42 and continuous within a plane. The holding member 43 is supported by the viscoelastic member 42 and includes a holding surface that holds the substrate W. The holding member 33 is formed as a plane on the viscoelastic member 42.

The holding member 33 has the same structure as the holding member 7 according to the first embodiment above, and the holding surface thereof is formed of an electric adhesive material that is capable of electrically changing an adhesive force.

When the substrate W is warped with respect to the surface of the hand 4, the holding member 43 and viscoelastic member 42 of the holding body 41 that is in contact with the substrate W are elastically deformed. Therefore, it becomes possible for the entire surface of the adhesive layer 10 of all (or a large portion) of the holding body 41 to adhere onto the substrate W.

As a result, this embodiment also bears the same effect as the first embodiment.

### Fifth Embodiment

A conveying apparatus according to a fifth embodiment will be described.

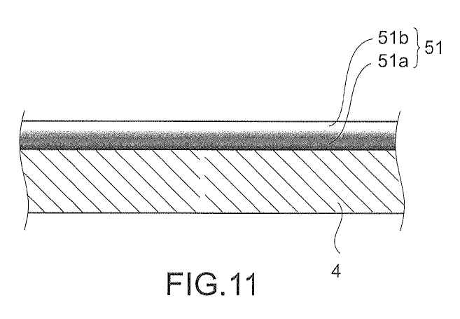

FIG. 11 is a cross-sectional diagram showing a holding body 51.

In descriptions below, descriptions on parts having the same structures as those of the above embodiments will be simplified.

As shown in the figure, the holding body 51 (bonding layer) is formed on the hand 4 (base body). The holding body 51 includes a viscoelastic area 51a on the hand 4 side and a holding area 51b on the other side. The holding body 51 is constituted of an adhesive medium and electric rheology particles dispersed in the adhesive medium and formed of an electric adhesive material that is capable of electrically changing an adhesive force. In this case, a content of the electric rheology particles in the adhesive medium is adjusted such that the density gradually decreases from the holding area 51b side toward the viscoelastic area 51a and hand 4 (base body) side. As a result, the electric adhesive material gradually becomes softer from the holding area 51b side toward the viscoelastic area 51a and hand 4 (base body) side (so that various elastic deformations become possible). In other words, the holding body 51 is structured as a single layer that has a gradient function and whose viscoelasticity gradually decreases from the holding area 51b side to the hand 4 (base body) side.

It should be noted that when the content of the electric rheology particles in the adhesive medium is low, the electric adhesive material itself becomes soft so as to be capable of undergoing various elastic deformations. Therefore, the content is high in the holding body 51, whereas the content is low in the viscoelastic area 51a.

It should be noted that although not shown, an electric field applying means for applying an electric field to the electric adhesive material is provided additionally.

The viscoelastic area 51a in the holding body 51 (bonding layer) can be elastically deformed.

The holding area 51b holds the substrate W using a frictional force. The holding area 51b is formed to have a high frictional force.

When the substrate W is warped with respect to the surface of the hand 4, the viscoelastic area 51a of the holding body 51 that is in contact with the substrate W is elastically deformed. Therefore, it becomes possible for the entire (or a large portion of) surface of the holding area 51b to adhere onto the substrate W to hold it. As a result, the substrate W can be surely held.

Further, the viscoelastic area 51a and the holding area 51b can be formed such that, by carrying out partial softening processing on elastomer of the holding body 51 or the like, for example, viscoelasticity of the elastomer gradually becomes softer from the holding area 51b toward the hand 4 (viscoelasticity gradually decreases so as to enable various elastic deformations to be performed). In this case, the holding body 51 can be constituted of a single member having a gradient function.

### Sixth Embodiment

A rotation-transmitting apparatus according to a sixth embodiment will be described.

In a rotation-transmitting apparatus that transmits a rotation by a driving disk and a driven disk coming into contact with each other, a rotation axis of the driving disk and that of the driven disk need to be coaxial. For example, when the rotation axis of the driving disk and that of the driven disk tilt by a vibration and the like, there is a fear that a load on a contact surface between the driving disk and the driven disk may lose its uniformity and an inconvenience such as a lopsided abrasion may occur. Therefore, an alignment mechanism or the like for keeping the rotation axes on the same axis becomes necessary. Here, for the rotation-transmitting apparatus according to this embodiment, a rotation-transmitting apparatus that allows a tilt of the rotation axes will be described.

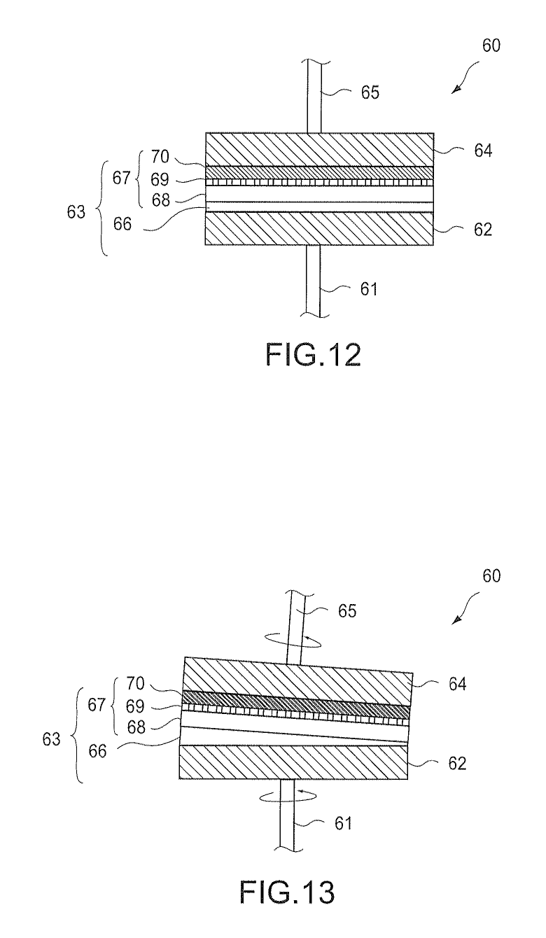

FIG. 12 is a cross-sectional diagram showing a rotation-transmitting apparatus 60.

In descriptions below, descriptions on parts having the same structures as those of the above embodiments will be simplified.

As shown in FIG. 12, the rotation-transmitting apparatus 60 includes a first spinning disk constituted of a driving axis 61, a driving disk 62, and a transmitting portion 63, a second spinning disk constituted of a driven disk 64, and a driven axis 65. The driving disk 62 is connected to the driving axis 61, and the driven disk 64 is connected to the driven axis 65. The driving disk 62 and the driven disk 64 face each other via the transmitting portion 63. It should be noted that it is also possible to use the driving axis 61 as a driven axis and the driven axis 65 as a driving axis.

The driving axis 61 is connected to an external driving source and rotates about an axis thereof.

The driving disk 62 rotates together with the driving axis 61. The driving disk 62 is formed in a disk shape.

The transmitting portion 63 transmits a rotation of the driving disk 62 to the driven disk 64 or does not transmit it at all, the details of which will be described later.

The driven disk 64 rotates based on the rotation transmitted from the transmitting portion 63. The driven disk 64 is formed in a disk shape.

The driven axis 65 rotates together with the rotation of the driven disk 64 and transmits the rotation to an external mechanism.

The structure of the transmitting portion 63 will be described in detail.

As shown in FIG. 12, the transmitting portion 63 is constituted of a viscoelastic member 66 (bonding layer) and a holding member 67. The viscoelastic member 66 is formed on the driving disk 62, and the holding member 67 is formed on the viscoelastic member 66.

The viscoelastic member 66 bonds the driving disk 62 and the holding member 67 and is structured as a bonding layer that is formed of a viscoelastic material that can be elastically deformed. The viscoelastic member 66 is formed of elastomer and can be elastically deformed. The viscoelastic member 66 is formed of a softer material than the holding member 67.

The holding member 67 includes an insulator layer 68, an electrode layer 69, and an adhesive layer 70. The insulator layer 68, the electrode layer 69, and the adhesive layer 70 are formed on the viscoelastic member 66 in the stated order. The adhesive layer 70 is formed of an electric adhesive material.

The electrode layer 69 is formed to be capable of applying an electric field to the adhesive layer 70 as in the first embodiment and includes a pectinated electrode, for example. The electrode layer 69 is connected to a wire (not shown) connected to an external power source. The adhesive layer 70 is laminated on the electrode layer 69 and is in contact with the driven disk 64 (adhered to driven disk 64).

An operation of the thus-structured rotation-transmitting apparatus 60 will be described.

The driving axis 61 and the driving disk 62 are rotated by an external driving source.

The rotation of the driving disk 62 is transmitted to the holding member 67.

When a predetermined voltage is applied to the electrode layer 69, the driven disk 64 is rotated by a frictional force of the adhesive layer 70.

The rotation is transmitted to the driven axis 65 connected to the driven disk 64.

When a voltage is not applied to the electrode layer 69, the driven disk 64 does not rotate since the adhesive force between the adhesive layer 70 and the driven disk 64 is large.

When a predetermined voltage is applied to the electrode layer 69, the adhesive force between the adhesive layer 70 and the driven disk 64 increases. As a result, the driven disk 64 rotates.

Moreover, a transmitting torque of the driving disk 62 may be set variably by differentiating the adhesive force between the adhesive layer 70 and the driven disk 64 based on the level of voltage applied to the electrode layer 69. As a result, a torque limit can be set with ease.

FIG. 13 is a diagram showing a tilted state of the holding member 67.

As shown in the figure, when the driven disk 64 tilts with respect to the driving disk 62, since the holding member 67 of this embodiment is structured to be capable of tilting with respect to the driving disk 62, it is possible for the entire surface of the adhesive layer 70 to adhere onto the driven disk 64 and transmit the rotation. Therefore, even when the rotation axes of the driving axis 61 and driven axis 65 tilt and the driving disk 62 and the driven disk 64 are not in parallel, a rotation driving force can be appropriately transmitted to the driven axis 65.

By providing the adhesive layer 70 formed of an electric adhesive material in the rotation-transmitting apparatus 60 of this embodiment and controlling a voltage with respect to the electrode layer 69, the rotation-transmitting force becomes variable. On the other hand, when constantly transmitting a rotation force of the driving disk 62 to the driven disk 64, it is possible to use a viscoelastic material for the adhesive layer 70 instead of the electric adhesive material. Moreover, instead of the adhesive layer 70, it is also possible to form a layer in a shape that intermeshes with the driven disk 64 (e.g., concavo-convex shape or shape of cutting blade) using a non-adhesive material such as metal so as to mechanically engage those two by bringing them into contact with each other. In this case, as in the above example, even when the rotation axes of the driving disk 62 and driven disk 64 tilt, the rotation can be transmitted stably.

### Seventh Embodiment

A conveying apparatus according to a seventh embodiment will be described.

In an air slider that lifts up a slider on which a conveying object is mounted so that it floats by ejecting air and conveys the slider, since the slider does not come into contact with a frame, the slider may vibrate due to a vibration that is caused when mounting the slider or an external factor. Therefore, when positioning accuracy of a conveying position is required in particular, the vibration needs to be suppressed. Here, regarding the conveying apparatus of this embodiment, a conveying apparatus that prevents the slider from vibrating during and after conveyance and thus obtains high positioning accuracy will be described.

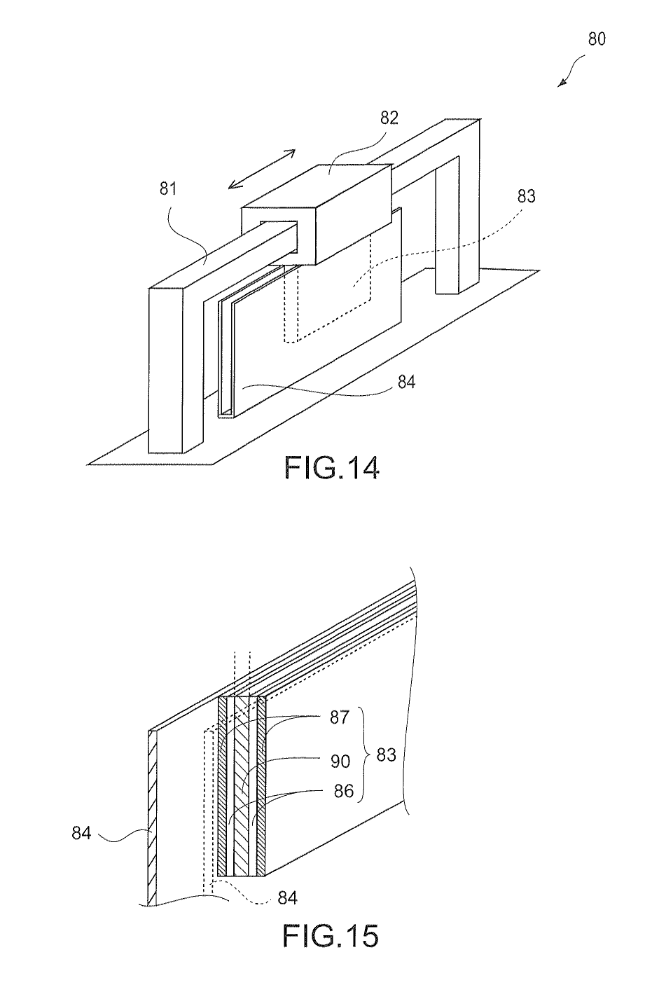

FIG. 14 is a perspective view showing a conveying apparatus 80.

In descriptions below, descriptions on parts having the same structures as those of the above embodiments will be simplified.

As shown in FIG. 14, the conveying apparatus 80 includes a frame portion 81 and an air slider 82.

The air slider 82 is attached to the frame portion 81.

The air slider 82 is movable with respect to the frame portion 81 in the direction indicated by the arrow while a conveying object is mounted thereon. The air slider 82 includes a movable portion 83 (movable element).

The frame portion 81 supports the air slider 82 and guides the movement of the air slider 82. The air slider 82 includes an air supplying hole (not shown). By supplying air between the frame portion 81 and the air slider 82 from the supplying hole, the air slider 82 can float from the frame portion 81. Moreover, the conveying apparatus 80 includes a fixing portion 84 (stator).

FIG. 15 is a perspective view showing the movable element 83 and the fixing portions 84.

As shown in the figure, the movable portion 83 is formed as a plate having both surfaces formed along a traveling direction of the air slider 82. The fixing portions 84 are formed as plates having surfaces opposing both surfaces of the movable portion 83. The movable portion 83 is accommodated between the fixing portions 84.

The movable portion 83 includes a base portion 90, viscoelastic members 86 (bonding layers) formed on both surfaces of the base portion 90, and holding members 87 formed on the viscoelastic members 86. The base portion 90 itself functions as an electrode, or the base portion 90 includes a layer that functions as an electrode. Moreover, although not shown, a control unit including a voltage source for applying a voltage to the base portion 90 and a switch for switching an application and a cancel of application of a voltage to the base portion 90 is connected to the base portion 90. The structure of the control unit is not limited to the example described above and may include a variable source that is capable of continuously changing an applying voltage. The voltage source may either be a DC power source or an AC power source.

The fixing portions 84 are each constituted of a conductive body and function as an electrode.

The viscoelastic members 86 bond the base portion 90 and the holding members 87 and are each structured as a bonding layer that is formed of a viscoelastic material that can be elastically deformed. The holding members 87 are formed of an electric adhesive material. The movable portion 83 is accommodated between the fixing portions 84 in a state where the viscoelastic members 86 are compressed (with elasticity maintained).

An operation of the thus-structured conveying apparatus 80 will be described.

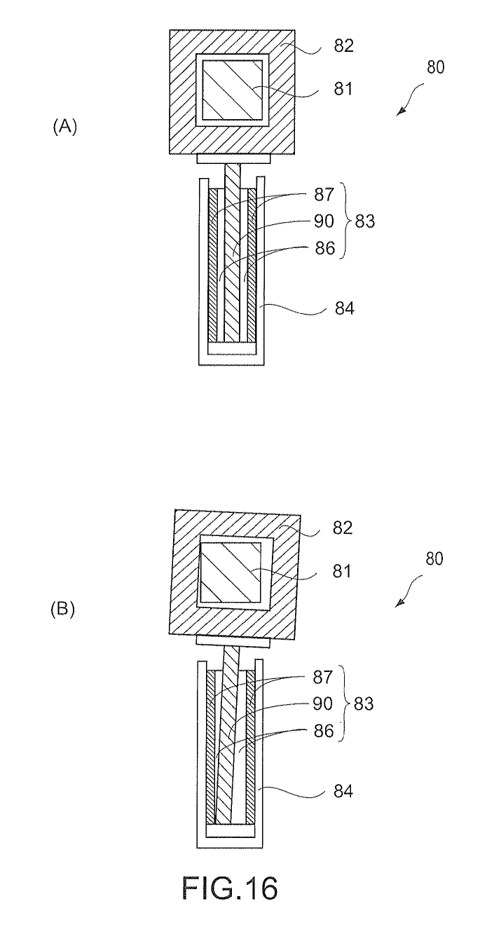

FIG. 16 are cross-sectional diagrams showing the conveying apparatus 80.

By supplying air between the frame portion 81 and the air slider 82 from the air supplying hole (not shown) provided in the air slider 82, the air slider 82 floats. By the adhesive force of the holding members 87 increasing by a voltage applied by the control unit between the base portion 90 and the fixing portions 84 and the holding members 87 thus adhering onto the fixing portions 84, the air slider 82 is fixed.

A conveying objected is mounted on the air slider 82, and a supply of voltage applied between the base portion 90 and the fixing portions 84 by the control unit is stopped. The adhesive force of the holding members 87 is lost, and the fixed air slider 82 is released. The air slider 82 is driven and moved to a predetermined position. At this time, the holding members 87 slide with the fixing portions 84.

A voltage is applied between the base portion 90 and the fixing portions 84 by the control unit again to thus increase the adhesive force of the holding members 87 and fix the air slider 82. In this state, the conveying object is removed.

The conveying object is conveyed as described above. Since the air slider 82 is fixed to the fixing portions 84 when the conveying object is mounted to and removed from the air slider 82, the air slider 82 is prevented from vibrating. Since the air slider 82 floats from the frame portion 81 in particular, it is necessary to prevent a vibration that is caused when the conveying object is mounted and removed. However, according to this embodiment, such an object can be easily achieved.

Further, by fixing the air slider 82 to the fixing portions 84 at a predetermined position when stopping the air slider 82, the air slider 82 can be stopped accurately. Moreover, instead of fixing the air slider 82, it is also possible to use a brake for decelerating the moving air slider 82.

It should be noted that although the base portion 90 and the fixing portions 84 constitute the electrode in this embodiment, the structure of the electrode is not limited thereto, and a pectinate electrode may be formed between the holding member 87 and the viscoelastic member 86, for example. In this case, the base portion 90 and the fixing portions 84 may each be an insulator.

Furthermore, the viscoelastic members 86 and the holding members 87 may be provided on inner surfaces of the fixing portions 84 instead of the base portion 90 side. In this case, the viscoelastic members 86 and the holding members 87 are formed on the fixing portions 84 in the stated order.

As shown in FIG. 16B, when the air slider 82 is tilted with respect to the frame portion 81 due to a disturbance, one of the viscoelastic members 86 is compressed by an elastic deformation, and the other one of the viscoelastic members 86 is restored (or expands) from the compressed state by the elastic deformation. As a result, the holding members 87 can be kept in parallel with the fixing portions 84, and the fixing portions 84 can surely hold the movable portion 83.

The present invention is not limited to the embodiments above and can be variously modified without departing from the gist of the present invention.

In the seventh embodiment above, the holding mechanism inhibits movement of the movable portion 83 by applying a voltage to the electric adhesive material. Instead, by making the level of voltage variable, it becomes possible to structure a control mechanism that controls a movement speed of the movable portion formed of an electric adhesive material.

In the sixth embodiment above, the rotation-transmitting apparatus that switches a connection and a release of connection between the driving disk and the driven disk by controlling ON/OFF of a voltage with respect to the electric adhesive material has been described. Alternatively, by making the level of voltage with respect to the electric adhesive material variable, it becomes possible to adjust a rotational force that is transmitted to the driven disk. As a result, a so-called half-clutch state can be realized.

In the first to fourth embodiments above, the holding member and the bonding layer have been distinguished from each other. However, as a different structure, it is possible to create a portion that functions as a holding member having an electric adhesion effect and a portion that functions as a bonding layer that has a low density of the electric rheology particles and allows an elastic deformation by partially changing a content of the electric rheology particles in the adhesive medium. In this case, the electric field applying means for applying an electric field to the electric adhesive material is provided additionally.

As a result, the holding member and the bonding layer can be integrated.

In the first to fourth embodiments above, the holding member includes the adhesive layer 10. However, the holding means is not limited thereto, and a material having a high friction coefficient such as elastomer can be used.

As a result, this embodiment also bears the same effect as the first embodiment.

Furthermore, as a different structure, it is possible to create a portion that functions as the holding member and a portion that functions as the bonding layer by carrying out partial cure processing using integrated elastomer, for example.

As a result, the holding member and the bonding layer can be integrated.

### DESCRIPTION OF SYMBOLS

1 conveying apparatus
4 hand (base body)
5 holding body
6 viscoelastic member (bonding layer)
7 holding member
10 adhesive layer
21 holding body
22 viscoelastic member (bonding layer)
23 holding member
31 holding body
32 viscoelastic member (bonding layer)
33 holding member
41 holding body
42 viscoelastic member (bonding layer)
43 holding member
51 holding body
51a viscoelastic area (bonding layer)
51b holding area
60 rotation-transmitting apparatus
62 driving disk
63 transmitting portion
64 driven disk
66 viscoelastic member
67 holding member
70 adhesive layer
80 conveying apparatus
81 frame portion
82 air slider
83 movable portion (movable element)
84 fixing portion (stator)
86 viscoelastic member (bonding layer)
87 holding member

1. A holding apparatus, comprising:
a base body; and
a holding body including a holding surface that comes into close contact with a holding object and a bonding layer that is formed of a viscoelastic material and bonds the holding surface to the base body.

2. The holding apparatus according to claim 1,
wherein the holding body further includes a holding layer including the holding surface, and
wherein the bonding layer bonds the holding layer to the base body.

3. The holding apparatus according to claim 2,
wherein the holding layer is formed of an electric adhesive material that is capable of electrically changing an adhesive force.

4. The holding apparatus according to claim 3,
wherein the holding layer further includes an electric field applying means for applying an electric field to the electric adhesive material.

5. The holding apparatus according to claim 4,
wherein the electric field applying means is constituted of an insulator layer formed on the bonding layer and an electrode layer formed on the insulator layer.

6. The holding apparatus according to claim 2,
wherein the holding layer is divided plurally for each area on the bonding layer.

7. The holding apparatus according to claim 6,
wherein the holding body is divided plurally for each area on the base body.

8. The holding apparatus according to claim 7,
wherein the base body includes a plurality of concave portions, and
wherein the holding body is accommodated in each of the concave portions.

9. The holding apparatus according to claim 1,
wherein the holding body is constituted of the bonding layer alone that includes the holding surface on a front surface thereof, and
wherein viscoelasticity of the bonding layer gradually decreases from the holding surface side to the base body side.

10. A conveying apparatus, comprising
the holding apparatus according to any claim 1, the holding apparatus being provided on a conveying surface of the conveying apparatus.

11. A rotation-transmitting apparatus, comprising:
a first spinning disk including a base body including a rotation axis, a holding surface, and a bonding layer that is formed of a viscoelastic material and bonds the holding surface to the base body; and
a second spinning disk that comes into close contact with the holding surface.

12. A conveying apparatus, comprising:
a stator; and
a movable element that includes a base body on which a conveying object is mounted, a contact surface that is formed of an electric adhesive material capable of electrically changing an adhesive force and comes into contact with the stator, and a bonding layer that is formed of a viscoelastic material and bonds the contact surface to the base body, the movable element being moved relative to the stator.

13. A conveying apparatus, comprising:
a movable element on which a conveying object is mounted; and
a stator including a base body, a contact surface that is formed of an electric adhesive material capable of electrically changing an adhesive force and comes into contact with the movable element, and a bonding layer that is formed of a viscoelastic material and bonds the contact surface to the base body.

14. The conveying apparatus according to claim 12, further comprising
a control unit configured to control the adhesive force of the electric adhesive material based on voltage application control,
wherein the control unit inhibits, by applying an electric field to the electric adhesive material, a relative movement of the movable element with respect to the stator and allows, by canceling the application of an electric field to the electric adhesive material, the relative movement of the movable element with respect to the stator.

15. The conveying apparatus according to claim 13, further comprising
a control unit configured to control the adhesive force of the electric adhesive material based on voltage application control,
wherein the control unit inhibits, by applying an electric field to the electric adhesive material, a relative movement of the movable element with respect to the stator and allows, by canceling the application of an electric field to the electric adhesive material, the relative movement of the movable element with respect to the stator.
